(19) United States
(12) Patent Application Publication
(10) Pub. No.: US 2025/0371988 A1
(43) Pub. Date: Dec. 4, 2025

(54) USER INTERFACE FOR AREA MANAGEMENT FOR UAV OPERATIONS

(71) Applicant: WING AVIATION LLC, Mountain View, CA (US)

(72) Inventors: Jonathan Kaplan, Waltham, MA (US); Fan Zhang, San Francisco, CA (US); Tara S. Rezvani, Los Gatos, CA (US); Reinaldo Negron, San Francisco, CA (US); Sam Ewen, San Francisco, CA (US); Simon Davey, San Francisco, CA (US)

(21) Appl. No.: 18/732,085

(22) Filed: Jun. 3, 2024

(51) Int. Cl. G08G 5/00; B64U 10/20

(52) U.S. Cl. CPC G08G 5/56; G08G 5/26; G08G 5/55; G08G 5/57; B64U 10/20

(57) ABSTRACT

An unmanned aerial vehicle fleet management system initiates creation of a digital airspace area of operation, presents in a user interface an area classifier selection field configured to select from a set of available area classifiers; receives first user input classifying the digital airspace area of operation as an oversight area; presents a ruleset selection field; receives second user input specifying one or more rulesets of the oversight area; creates the oversight area based at least in part on the first and second inputs; and creates a pilot area associated with the oversight area that inherits the specified ruleset(s) of the oversight area. The oversight area and pilot area define areas of operation of different types for different classes of users, such as pilots and flight operations managers. The specified ruleset(s) comprise rules related to flight approvals. Flight missions can be created or altered based on the specified ruleset(s).

### TECHNICAL FIELD

This disclosure relates generally to unmanned vehicles, and in particular but not exclusively, relates to managing airspace of unmanned aerial vehicles.

### BACKGROUND INFORMATION

An unmanned vehicle, which may also be referred to as an autonomous vehicle, is a vehicle capable of traveling without a physically present human operator. Various types of unmanned vehicles exist for various different environments. For instance, unmanned vehicles exist for operation in the air, on the ground, underwater, and in space. Unmanned vehicles also exist for hybrid operations in which multi-environment operation is possible. Unmanned vehicles may be provisioned to perform various different missions, including payload delivery, exploration/reconnaissance, imaging, public safety, surveillance, or otherwise. The mission definition will often dictate a type of specialized equipment and/or configuration of the unmanned vehicle.

Unmanned aerial vehicles (also referred to as drones) may be adapted for package delivery missions to provide an aerial delivery service. One type of unmanned aerial vehicle (UAV) is a vertical takeoff and landing (VTOL) UAV. VTOL UAVs are particularly well-suited for package delivery missions. The VTOL capability enables a UAV to take off and land within a small footprint thereby providing package pick-ups and deliveries almost anywhere. To safely deliver packages in a variety of environments (particularly populated urban/suburban environments), a UAV delivery service should be capable of quickly and efficiently defining and managing areas of operation for UAVs.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates operation of an unmanned aerial vehicle (UAV) delivery service that delivers packages into a neighborhood, in accordance with an embodiment of the disclosure.

FIG. 2A is a perspective view illustration of a UAV configured for use in a UAV delivery system, in accordance with an embodiment of the disclosure.

FIG. 2B is an underside plan view illustration of the UAV configured for use in the UAV delivery system, in accordance with an embodiment of the disclosure.

FIG. 3 is a functional block diagram that illustrates a non-limiting example embodiment of a UAV according to various aspects of the present disclosure.

FIG. 4 is a functional block diagram that illustrates a non-limiting example embodiment of a fleet management system according to various aspects of the present disclosure.

FIGS. 5A and 5B illustrate an example information collection user-interface (UI) for creating digital airspace areas of operation, in accordance with an embodiment of the disclosure.

FIGS. 6A and 6B illustrate UI elements for editing digital airspace areas of operation, in accordance with an embodiment of the disclosure.

FIG. 7 is a flow chart illustrating operation of an information collection UI, in accordance with an embodiment of the disclosure.

### DETAILED DESCRIPTION

Embodiments of a system, apparatus, and method for creating, editing, and otherwise managing digital airspace areas of operation for an unmanned aerial vehicles (UAVs) are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As UAV delivery services expand leveraging automation to process an increasing number of delivery orders, plan routes, and execute flight missions, the ability to effectively and timely manage airspace in a scalable manner is increasingly important.

Digital airspace areas of operation are software constructs that are used to define areas where flight operations are allowed. Previously, it was necessary for system engineers to reprogram corresponding aspects of an airspace management system (e.g., on the command line) each time an area of operation was defined or modified.

Typically, system engineers are not trained in airspace management, so airspace administrators would first need to provide information to system engineers, who would then translate that information into newly created or modified areas of operation. These factors contributed to delays and errors in creation of such constructs.

To address these and other technical challenges, embodiments of an information collection user-interface (UI) adapted for creating and/or modifying digital airspace areas of operation are described. In described embodiments, areas of operation have different classifiers depending on the nature of the area, such as a pilot area (which may be overseen by a pilot responsible for controlling one or more UAVs) or an oversight area (which may be overseen by a flight operations manager). Areas with different classifiers have different metadata associated with them, which may be used by backend systems to ensure compliant operations. In various embodiments, the information collection UI includes a selectable field where a human supervisor can quickly select an area classifier from a plurality of available area classifiers, such as oversight areas and pilot areas, and fields that allow a user to draw or upload 2D geometry of the area of operation (in formats such as the geoJSON format for encoding geographic data structures) and define altitude as a third dimension of the area of operation. When further combined with a time dimension (e.g., a start time, or a start time paired with an end time), the area of operation can be considered a four-dimensional (4D) space in which flight operations are permitted.

Areas of operation that are generated in accordance with described embodiments can be used to signal availability coverage to plan airspace operations. For example, an airspace operations team can use an area of operation to signal which areas are available, and at what times, for UAV flight operations. In described embodiments, the 4D space of an area of operation can be used to indicate a 3D volume that is available for a particular time or an indefinite time. In an illustrative scenario, an area of operation is defined as a 3D volume that is available for flight operations until expiring at a future time (e.g., 13:00 Dec. 12, 2024 UTC). The system can check a planned flight against the parameters of the area of operation to determine whether the flight is permitted. For example, if in the above scenario a flight is due to begin one minute before expiration and will last for 10 minutes, the area of operation will expire before the flight is completed, the system can disallow the planned flight because the availability coverage will not be sufficient for that flight to be completed.

Illustrative details of such techniques are described below.

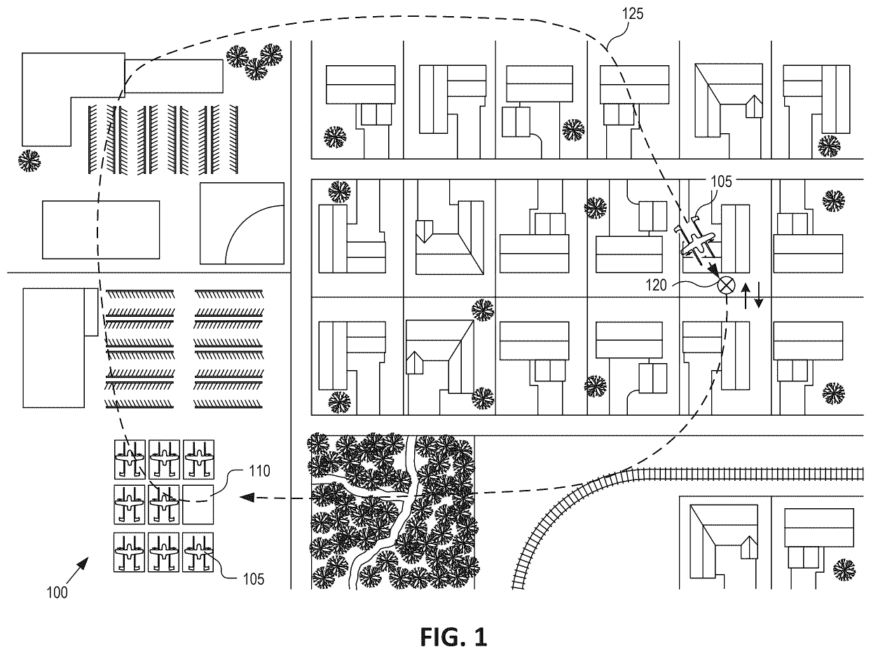

In general, UAVs may be provisioned to perform a variety of different mission types, including package delivery, aerial photography, public safety, etc. These UAVs may stage from an operations facility where many UAVs operate. FIG. 1 depicts an illustrative package delivery service scenario for a suburban neighborhood, which is included in a digital airspace area of operation. FIG. 1 includes an example terminal area (or “nest”) 100 staging a plurality of UAVs, such as UAV 105, for servicing a nearby neighborhood. In the example shown in FIG. 1, nest 100 includes staging pads 110 such as launching pads, landing pads, charging pads, or any combination thereof.

In an illustrative delivery scenario, workers attach a package to UAV 105 on a staging pad 110. UAV 105 is given an order regarding where the delivery will be made (e.g., delivery zone 120). A software system (e.g., a back-end planner system) calculates the route 125 based on a mission request (e.g., a specification of a delivery to be made to a customer). Once the route 125 is successfully planned and approved, the UAV 105 takes off and makes the delivery according to the calculated route. Alternatively, an on-board software system may operate in combination with a back-end system, or independently, to calculate the route 125. Multiple delivery missions may be occurring at a given time, with other UAVs taking off from and landing on other staging pads 110 within nest 100.

Techniques for creating and/or managing digital airspace areas of operation are described in further detail below.

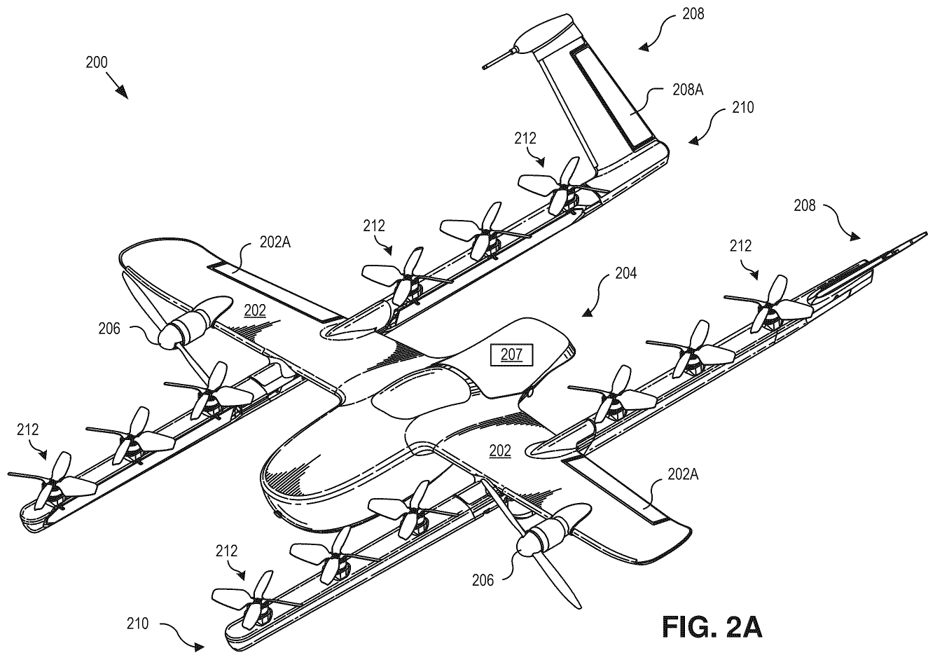

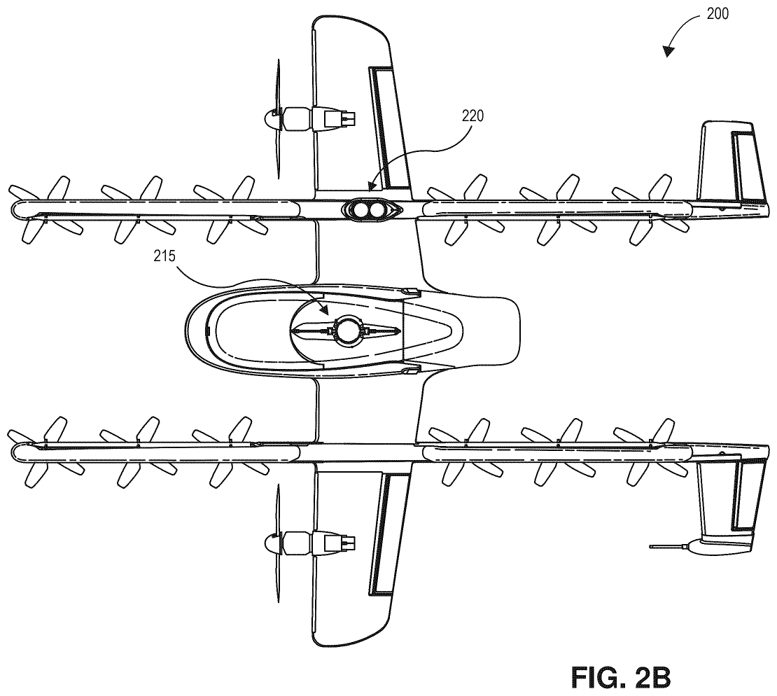

FIGS. 2A and 2B illustrate features of an illustrative UAV that is well suited for various types of UAV missions including package delivery, aerial photography, public safety, or otherwise, in accordance with embodiments described herein.

FIG. 2A is a topside perspective view illustration of UAV 200 while FIG. 2B is a bottom side plan view illustration of the same. UAV 200 is one possible implementation of UAVs 105 illustrated in FIG. 1, although other types of UAVs may be implemented as well.

The illustrated embodiment of UAV 200 is a vertical takeoff and landing (VTOL) UAV that includes separate propulsion units 206 and 212 for providing horizontal and vertical propulsion, respectively. UAV 200 is a fixed-wing aerial vehicle, which as the name implies, has a wing assembly 202 that can generate lift based on the wing shape and the vehicle's forward airspeed when propelled horizontally by propulsion units 206. The illustrated embodiment of UAV 200 has an airframe that includes a fuselage 204 and wing assembly 202. In one embodiment, fuselage 204 is modular and includes a battery module, an avionics module, and a mission payload module. These modules are secured together to form the fuselage or main body.

The battery module (e.g., fore portion of fuselage 204) includes a cavity for housing one or more batteries for powering UAV 200. The avionics module (e.g., aft portion of fuselage 204) houses flight control circuitry of UAV 200, which may include a processor and memory, communication electronics and antennas (e.g., cellular transceiver, Wi-Fi transceiver, etc.), and various sensors (e.g., global navigation satellite system (GNSS) sensors, an inertial measurement unit (IMU), a magnetic compass, a radio frequency identifier reader, etc.). Collectively, these functional electronic subsystems for controlling UAV 200, communicating, and sensing the environment may be referred to as an onboard control system 207. The mission payload module (e.g., middle portion of fuselage 204) houses equipment associated with a mission of UAV 200. For example, the mission payload module may include a payload actuator 215 (see FIG. 2B) for dispensing and recoiling a line when picking up a package during a package delivery mission. In some embodiments, the mission payload module may include camera/sensor equipment (e.g., camera, lenses, radar, lidar, pollution monitoring sensors, weather monitoring sensors, scanners, etc.). In FIG. 2B, an onboard camera system 220 is mounted to the underside of UAV 200 to support a machine vision system (e.g., monovision frame camera, stereoscopic machine vision, event camera, lidar depth camera, etc.) for visual triangulation, localization, and navigation as well as operate as an optical code scanner for reading visual codes affixed to packages.

As illustrated, UAV 200 includes horizontal propulsion units 206 positioned on wing assembly 202 for propelling UAV 200 horizontally. UAV 200 further includes two boom assemblies 210 that secure to wing assembly 202. Vertical propulsion units 212 are mounted to boom assemblies 210. Vertical propulsion units 212 providing vertical propulsion. Vertical propulsion units 212 may be used during a hover mode where UAV 200 is descending (e.g., to a delivery location), ascending (e.g., at initial launch or following a delivery), or maintaining a constant altitude. Stabilizers 208 (or tails) may be included with UAV 200 to control pitch and stabilize the aerial vehicle's yaw (left or right turns) during cruise. In some embodiments, during cruise mode vertical propulsion units 212 are disabled or powered low and during hover mode horizontal propulsion units 206 are disabled or powered low.

During flight, UAV 200 may control the direction and/or speed of its movement by controlling its pitch, roll, yaw, and/or altitude. Thrust from horizontal propulsion units 206 is used to control air speed. For example, the stabilizers 208 may include one or more rudders 208A for controlling the aerial vehicle's yaw, and wing assembly 202 may include elevators for controlling the aerial vehicle's pitch and/or ailerons 202A for controlling the aerial vehicle's roll. While the techniques described herein are particularly well-suited for VTOLs providing an aerial delivery service, it should be appreciated that embodiments are not thus limited.

Many variations on the illustrated fixed-wing aerial vehicle are possible. For instance, aerial vehicles with more wings (e.g., an “x-wing” configuration with four wings), are also possible. Although FIGS. 2A and 2B illustrate one wing assembly 202, two boom assemblies 210, two horizontal propulsion units 206, and six vertical propulsion units 212 per boom assembly 210, it should be appreciated that other variants of UAV 200 may be implemented with more or less of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

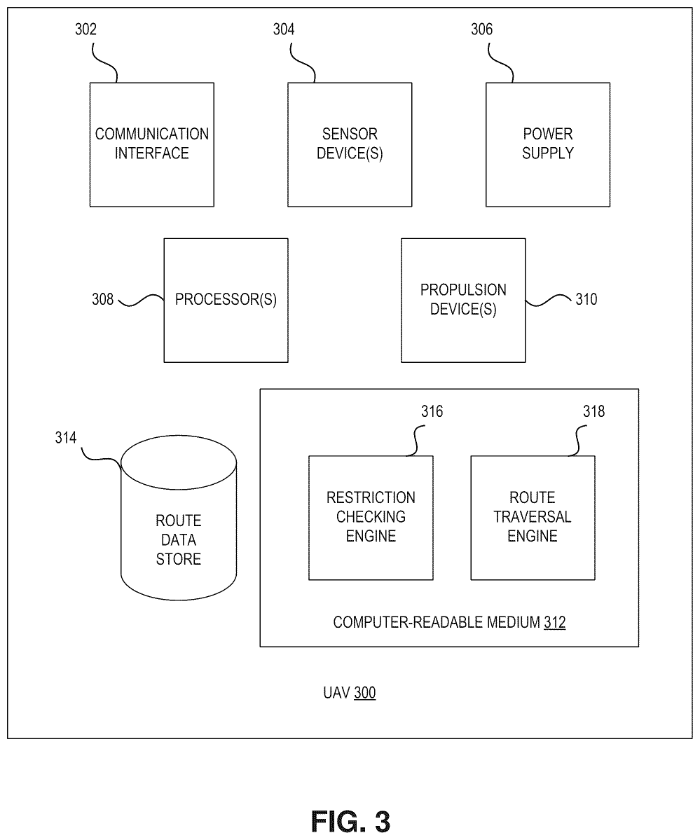

FIG. 3 is a functional block diagram that illustrates a non-limiting example embodiment of a UAV 300 according to various aspects of the present disclosure. UAV 300 is one possible implementation of UAVs 105 or 200. As shown, the UAV 300 includes a communication interface 302, one or more sensor devices 304, a power supply 306, one or more processors 308, one or more propulsion devices 310, a computer-readable medium 312, and a route data store 314.

In some embodiments, the communication interface 302 includes hardware and software to enable any suitable communication technology for communicating with a fleet management system. In some embodiments, the communication interface 302 includes multiple communication interfaces, each for use in appropriate circumstances. For example, the communication interface 302 may include a long-range wireless interface such as a 4G or LTE interface, or any other type of long-range wireless interface (e.g., 2G, 3G, 5G, or WiMAX), to be used to communicate with the fleet management system while traversing a route (also referred to as a flight mission). The communication interface 302 may also include a medium-range wireless interface such as a Wi-Fi interface to be used when the UAV 300 is at an area near a start location or an endpoint where Wi-Fi coverage is available. The communication interface 302 may also include a short-range wireless interface such as a Bluetooth interface to be used when the UAV 300 is in a maintenance location or is otherwise stationary and waiting to be assigned a route. The communication interface 302 may also include a wired interface, such as an Ethernet interface or a USB interface, which may also be used when UAV 300 is in a maintenance location or is otherwise stationary and waiting to be assigned a route.

In some embodiments, the sensor devices 304 include one or more vehicle state sensor devices that are configured to detect states of various components of the UAV 300, and to transmit signals representing those states to other components of the UAV 300. Some non-limiting examples of such sensor devices 304 include a battery state sensor, a propulsion device health sensor, an accelerometer, an attitude sensor, or otherwise. In some embodiments, the sensor devices 304 include one or more environmental sensor devices that are configured to detect information regarding the environment of UAV 300. Some non-limiting examples of such sensor devices 304 include visible light cameras, infrared cameras, LIDAR sensor devices, radar sensor devices, temperature sensors, altimeters, barometers, and positioning sensor devices (including but not limited to global navigation satellite system (GNSS) sensors).

In some embodiments, the power supply 306 may be any suitable device or system for storing and/or generating power. Some non-limiting examples of a power supply 306 include one or more batteries, one or more solar panels, a fuel tank, and combinations thereof. In some embodiments, the propulsion devices 310 may include any suitable devices for causing the UAV 300 to travel along the route, such as those described in connection with FIGS. 2A and 2B.

In some embodiments, the processors 308 may include any type of computer processor capable of receiving signals from other components of the UAV 300 and executing instructions stored on the computer-readable medium 312. In some embodiments, the computer-readable medium 312 may include one or more devices capable of storing information for access by the processor 308. In some embodiments, the computer-readable medium 312 may include one or more of a hard drive, a flash drive, an EEPROM, and combinations thereof.

As shown, the computer-readable medium 312 has stored thereon a route traversal engine 318 and a route checking engine 316. In some embodiments, the route traversal engine 318 is configured to cause the propulsion device 310 to propel the UAV 300 along routes stored in the route data store 314. The route traversal engine 318 may use signals from sensor devices 304, such as GNSS sensor devices, vision-based navigation devices, accelerometers, LIDAR devices, and/or other devices that are not illustrated or described further herein, to assist in positioning and navigation as is typical for UAV 300. In some embodiments, the route checking engine 316 is configured to compare a current or predicted future position of the UAV 300 to one or more digital airspace areas of operation or airspace restrictions, and to cause UAV 300 to take a corrective action in response to determining that the current or predicted future position of the UAV 300 is or will be within the restricted airspace or outside a digital airspace area of operation.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

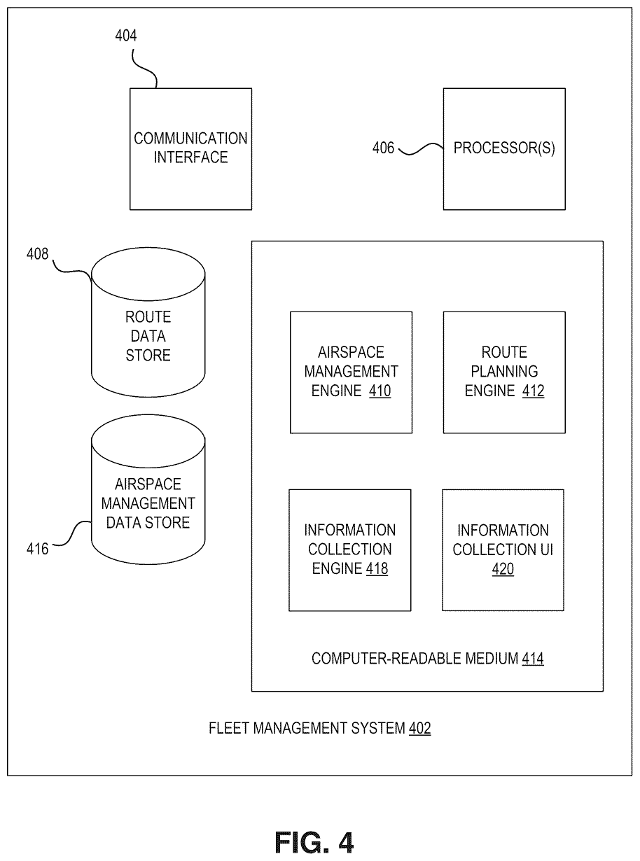

FIG. 4 is a functional block diagram that illustrates a non-limiting example embodiment of a fleet management system 402 according to various aspects of the present disclosure. Fleet management system 402 may include any number of one or more suitable computing devices configured to collectively provide the functionality of fleet management system 402, including but not limited to desktop computing devices, laptop computing devices, server computing devices, and computing devices of a cloud computing system. In some embodiments, each of the computing devices of fleet management system 402 may have all of the components illustrated in FIG. 4. In some embodiments, some computing devices of fleet management system 402 may have some (but not all) of the components illustrated in FIG. 4, while other computing devices of fleet management system 402 may have other components illustrated in FIG. 4.

As shown, fleet management system 402 includes a communication interface 404, one or more processors 406, and a computer-readable medium 414. In some embodiments, processors 406 include any suitable type of general-purpose computer processor, but may also include one or more special-purpose computer processors or AI accelerators optimized for specific computing tasks, including but not limited to graphical processing units (GPUs), vision processing units (VPUs), and tensor processing units (TPUs). In some embodiments, the communication interface 404 includes hardware and/or software suitable for communication with a communication interface 302 as described above of the autonomous vehicles 300 in a fleet. In some embodiments, communication interface 404 may also include hardware and/or software suitable for communicating with other computing systems via one or more of any wired or wireless technologies.

As shown, the computer-readable medium 414 has stored thereon logic for providing an airspace management engine 410, a route planning engine 412, an information collection engine 418, and an information collection UI 420. In some embodiments, the airspace management engine 410 is configured to generate or modify digital airspace areas of operation in which UAVs 300 are permitted to operate, and may be configured to transmit such information to UAVs 300 and/or store entries related to such areas of operation in airspace management data store 416. In some embodiments, the airspace management engine 410 is also configured to determine airspace in which operation of UAVs 300 is in some way restricted or limited, and may be configured to transmit such airspace restrictions to UAVs 300 and/or may be configured to store entries related to such airspace restrictions in airspace management data store 416. In some embodiments, the route planning engine 412 is configured to plan routes (e.g., flight missions) for UAV 300, to store the planned routes in a route data store 408, and to transmit the planned routes to UAVs 300.

In some embodiments, the route planning engine 412 may take information in the airspace management data store 416 into account while planning routes. For example, the route planning engine may take the parameters of digital airspace areas of operation into consideration when planning routes, to ensure that a planned route is within a 4D space (3D volume and time constraint) defined by an area of operation.

Information relevant for airspace management may be collected from various sources. In some scenarios, the information source is a digital data source collected in an automated manner by information collection engine 418. An example digital data source is an Automatic Dependent Surveillance-Broadcast (ADS-B), radar feeds, GNSS feeds, etc. The digital data source feeds may be collected/filtered by information collection engine 418 and provided to airspace management engine 410. For non-digital data sources, or data feeds that otherwise require human supervision, interpretation, or intervention, information collection UI 420 is provided. Information collection UI 420 facilitates the efficient creation/modification of airspace management areas by human supervisors. The airspace management areas created/modified with information collection UI 420 may also be stored as entries in airspace management data store 416.

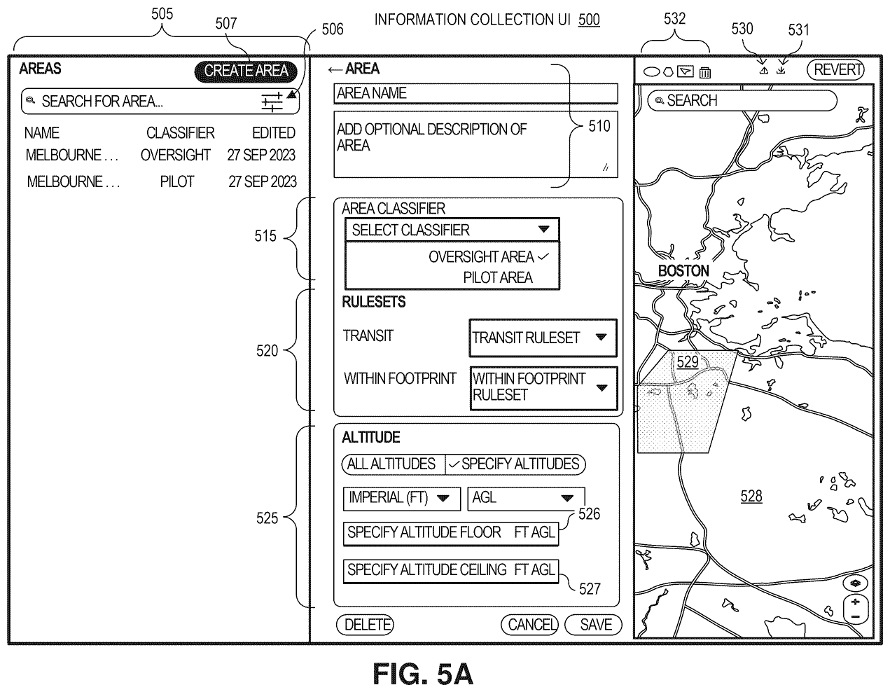

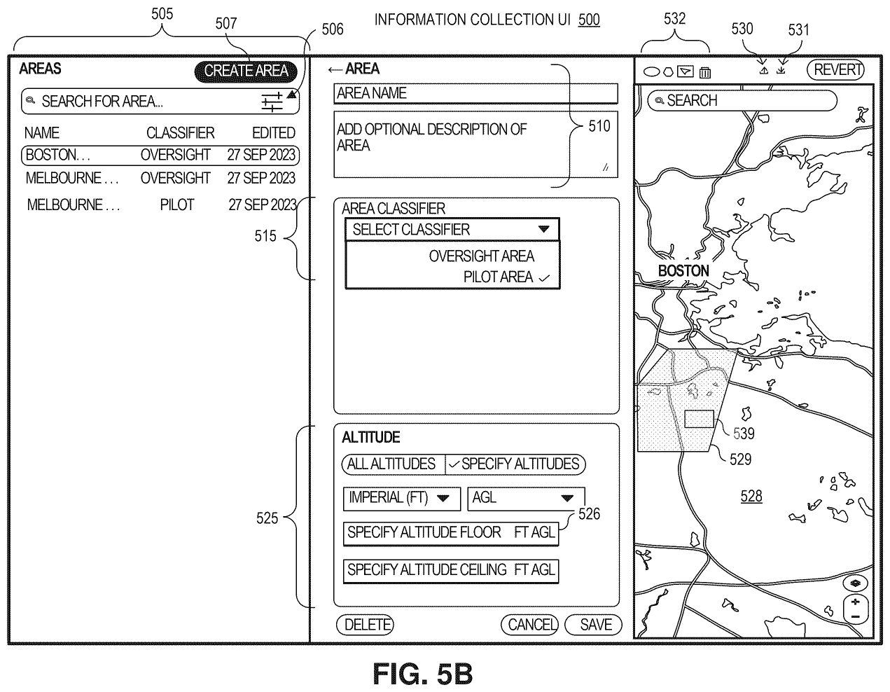

FIG. 5A illustrates an example information collection UI 500, in accordance with an embodiment of the disclosure. Information collection UI 500 is one possible implementation of information collection UI 420. The illustrated embodiment of UI 500 includes functionality for collecting information to create digital airspace areas of operation. As shown, the UI 500 includes an area list field 505, description fields 510, a selectable area classifier field 515, ruleset selection fields 520, altitude fields 525, and a geographical area selection field 528. The illustrated embodiment of altitude fields 525 includes floor and ceiling altitude fields 526 and 527.

In the illustrated embodiment, area list field 505 is displayed within UI 500 adjacent to description fields 510, selectable area classifier field 515, ruleset selection fields 520, and altitude fields 525. Area list field 505 includes a list of existing digital airspace areas of operation previously created and entered into airspace management data store 416. The human supervisor can select an existing area of operation to view or modify. In the illustrated embodiment, organization of the listed areas is provided by a filter option 506. In some embodiments, available filter options include an area status (e.g., not yet active, active, expired), an area classifier (e.g., oversight area or pilot area, as discussed below), last edited by, active date ranges, or the like. These filters can help human supervisors quickly find and edit existing areas of operation. Area list field 505 further includes a create area option 507 to create a new area of operation.

Upon selecting the create area option 507, the human supervisor is able to populate or edit fields corresponding to the area to be created, such as description fields 510, selectable area classifier field 515, ruleset selection fields 520, altitude fields 525, and geographical area selection field 528 for the area of operation. The editable fields for a particular area may vary depending on, for example, the selected area classifier, as explained below. In the illustrated embodiment, description fields 510 are text fillable description fields that enable the human supervisor to input a descriptive name for the airspace management area and an optional description.

The selectable area classifier field 515, ruleset selection fields 520, altitude fields 525, and geographical area selection field 528 are further fields describing characteristics of the airspace management area. In the illustrated embodiment, selectable area classifier field 515 is a drop-down menu that enables the user to select from a plurality of available area classifiers (e.g., oversight area, pilot area) for the area of operation.

The area classifiers define areas of operation of different types for different classes of users, such as pilot areas for pilots and oversight areas for flight operations managers. In some embodiments, pilot areas are nested within oversight areas and inherit features of the oversight areas in which they exist, such as rulesets comprising rules related to flight approvals. In the example shown in FIG. 5A, the selectable area classifier field 515 specifies the area of operation as an oversight area in which rulesets may be selected.

As shown in FIG. 5A, ruleset selection fields 520 are drop-down lists that enable the user to select from a plurality of available rulesets for an oversight area. In some embodiments, the available rulesets comprise rules that define types or characteristics of aircraft operations that may be performed in volumes of airspace in the corresponding areas of operation. In some embodiments, the rules may be static or dynamic. Static rules may include logic that can determine whether a requested flight is authorized based on characteristics of the request and information stored by the system (e.g., whether a given volume of airspace is available for UAV operations, or whether the given volume of airspace is permanently restricted, etc.). Dynamic rules may include logic that queries one or more third party data sources to determine whether a requested flight is authorized based on dynamic conditions (e.g., whether prevailing weather conditions allow a given type of UAV to operate; whether one or more temporary flight restrictions have been issued, etc.).

In the example shown in FIG. 5A, ruleset selection fields 520 allow selection from a plurality of available rulesets for different flight categories (e.g., “transit” or “within footprint”) for an oversight area. In this example, “within footprint” refers to flights taking place within a defined airspace (e.g., originating and ending within the defined airspace, and remaining within the defined airspace), and “transit” refers to flights that travel outside the defined airspace (e.g., flights that transit through the defined airspace but are at least partially outside the defined airspace). In an illustrative scenario, the defined airspace is an airspace in which only authorized users are permitted to operate, which may be defined by, e.g., a geofence or other boundary, and may be controlled by, e.g., an owner or administrator of a staging pad group or nest. Different flight categories, each of which may have different considerations for approval of flight operations, and therefore different corresponding rulesets.

Altitude fields 525 are presented within information collection UI 500 to solicit altitude information for the area of operation. As shown, the user may select “all altitudes” to indicate that the area of operation applies to all altitudes (e.g., with no altitude floor or ceiling) in a specified geographical area, or the user may select “specify altitudes” to specify an altitude floor or ceiling for the specified geographical area. The illustrated embodiment of altitude fields 525 includes floor and ceiling altitude fields 526 and 527. The floor and ceiling fields are provided to define the z axis boundary (i.e., altitude boundary) of the area of operation. The floor and ceiling fields may optionally be specified as an above ground level (AGL) value or a mean sea level (MSL) value.

Geographical area selection field 528 includes a 2D map upon which one or more shapes may be drawn to define x-y axis boundaries (i.e., longitude/latitude boundaries) of digital airspace areas of operation. In the example shown in FIG. 5A, the shape 529 in the geographical area selection field 528 represents an oversight area. The geographical area selection field 528 further provides drawing tools 532 to facilitate quick drawing of the x-y axis boundaries. These drawing tools 532 may include an option to select a scalable geometric shape (e.g., circle, oval, various polygons, etc.) or manually draw a polygon. A user drawn polygon may be saved by selecting a save shape option 530 and automatically redrawn or reused when creating another area of operation by selecting a recall shape option 531.

In the example shown in FIG. 5B, creation of a pilot area within a previously created oversight area is illustrated. In this example, the selectable area classifier field 515 specifies the area of operation as a pilot area. No ruleset fields are present because the pilot area inherits the rulesets of the oversight area with which it is associated. The functions of the altitude fields 525 and the geographical area selection field 528 are similar to the functions described above with reference to FIG. 5A.

In the example shown in in FIG. 5B, a further shape 539 has been drawn which represents the location of the pilot area within the shape 529 representing the oversight area. In some embodiments, pilot areas correspond to nest locations, with the extent of the pilot area being determined based on the range of UAVs assigned to the respective nests. In such embodiments, the geographical extent of the pilot areas may in some cases be automatically determined based on known nest locations and UAV range information. However, pilot areas also may be defined in other ways, and may be independent of nest locations or UAV range information.

An oversight area may include multiple pilot areas. For example, an oversight area containing n nests may include n corresponding pilot areas in a 1:1 relationship. Alternatively, individual pilot areas may include multiple nests, or multiple pilot areas may be assigned to a single nest.

In the examples shown in FIGS. 5A and 5B, no UI elements for selection of time parameters are provided. In these examples, a default setting specifies that the corresponding areas of operation are valid from the time they are created and last indefinitely, until being canceled or deleted. Alternatively, UI elements can be provided to allow users to specify start times and/or end times for areas of operation, or time parameters can be determined in some other way.

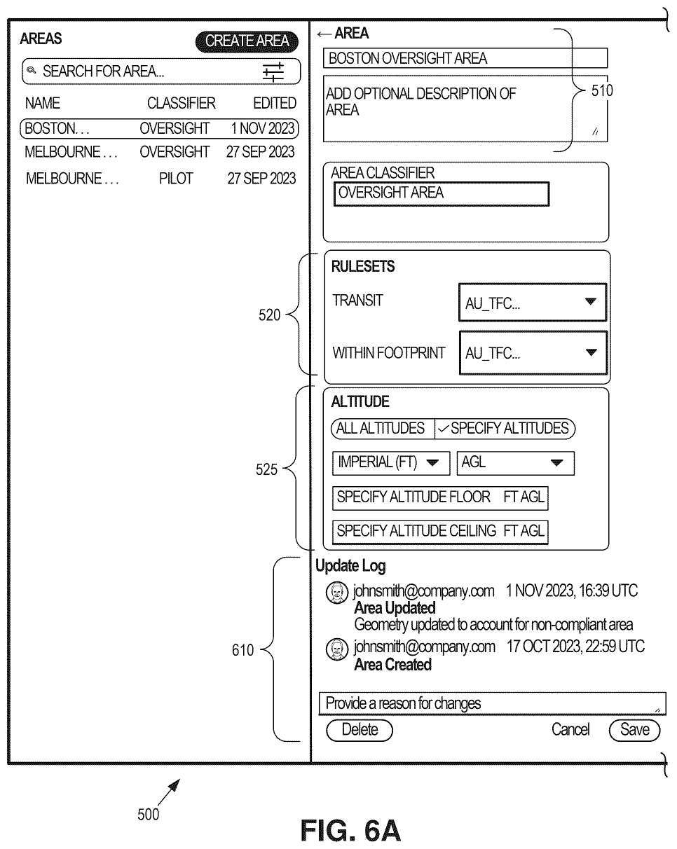

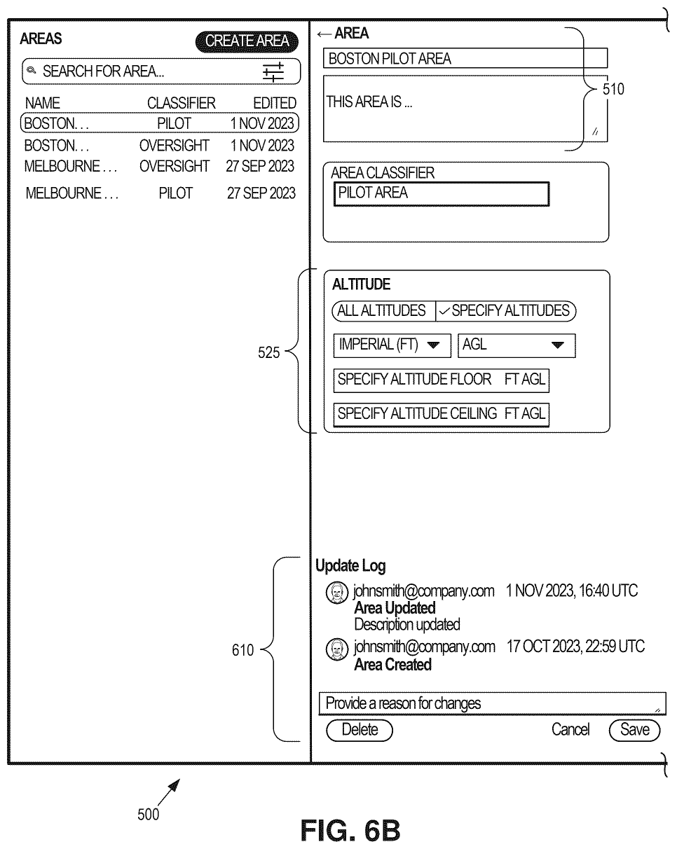

FIGS. 6A and 6B illustrate UI elements for editing existing digital airspace areas of operation, in accordance with an embodiment of the disclosure. In the example shown in FIG. 6A, an existing oversight area has been selected for viewing or editing. In this example, the UI 500 includes elements that permit editing of certain features of the oversight area, such as the description (via description fields 510), the corresponding rulesets (via ruleset selection fields 520), the corresponding altitude (via altitude fields 525), and the location or geographical area (via geographical area selection field 528, not shown in FIG. 6A). Other features of the oversight area may not be available for editing, such as the area classifier. The UI 500 also includes an update log 610 that tracks when and by whom changes were made and enables the user to include notes describing the reason for each change.

In the example shown in FIG. 6B, an existing pilot area has been selected for viewing or editing. In this example, the UI 500 permits editing of certain features of the pilot area, such as the description (via description fields 510), the corresponding altitude (via altitude fields 525), and the location or geographical area (via geographical area selection field 528, not shown in FIG. 6B). Other features of the pilot area are not available for editing, such as the corresponding rulesets (which are inherited from an associated oversight area), or the area classifier. Thus, the elements presented in the UI 500 that permit editing can vary depending on whether the existing digital airspace area of operation is an oversight area or a pilot area. The UI 500 also includes an update log 610 that tracks when and by whom changes were made and enables the user to include notes describing the reason for each change. In some embodiments, the UI 500 requires the user to include notes on each change to an oversight area or pilot area before that change is accepted.

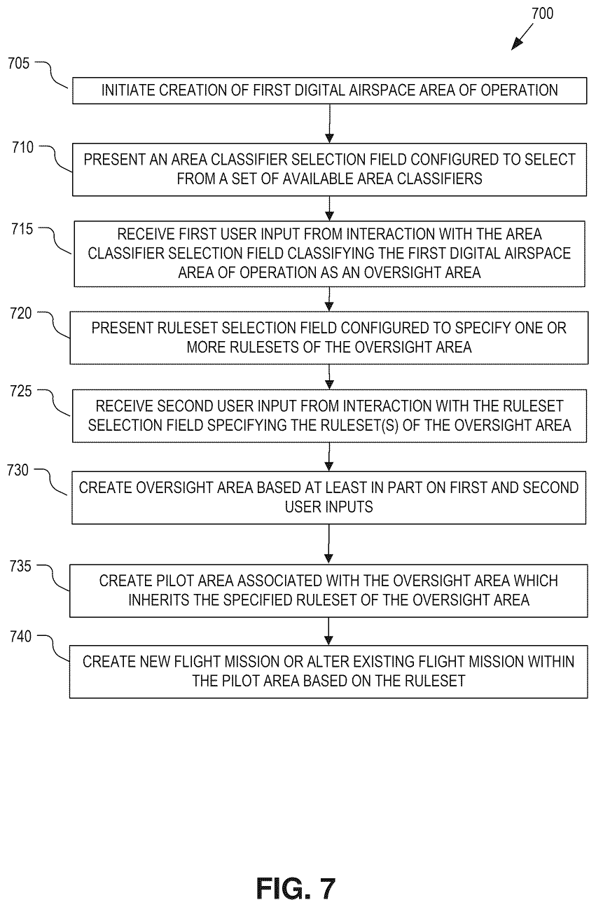

FIG. 7 is a flow chart illustrating a process 700 for operation of information collection UI 500 (or 420) for the creation of an digital airspace area of operation, in accordance with an embodiment of the disclosure. The order in which some or all of the process blocks appear in process 700 should not be deemed limiting. Rather, one of ordinary skill in the art having the benefit of the present disclosure will understand that some of the process blocks may be executed in a variety of orders not illustrated, or even in parallel.

In a process block 705, the fleet management system initiates creation of a digital airspace area of operation. In an illustrative scenario, a flight operations manager selects “create an area” within information collection UI 500 to initiate creation of a new area of operation that will be saved as a new entry in airspace management data store 416.

In process block 710, the system presents in the UI 500 an area classifier selection field configured to select from a set of available area classifiers, and in process block 715 the system receives first user input from interaction with the area classifier selection field classifying the digital airspace area of operation as an oversight area. In an illustrative scenario, the flight operations manager selects the area classifier from a drop-down list of available area classifiers (e.g., oversight area or pilot area).

In process block 720, the system presents in the UI 500 a ruleset selection field, and in process block 725, the system receives second user input from interaction with the ruleset selection field specifying a ruleset of the oversight area. In an illustrative scenario, the flight operations manager selects the ruleset from a drop-down list of available rulesets for the oversight area. In process block 730, the system creates the oversight area based at least in part on the first and second inputs.

In process block 735, the system creates a pilot area associated with the oversight area (e.g., within the oversight area or at least partially overlapping the oversight area) which inherits the specified ruleset of the oversight area. In some embodiments, the pilot area is created in response to further user input, as described above. For example, in some embodiments, creating the pilot area comprises initiating creation of a second digital airspace area of operation, receiving third user input from interaction with the area classifier selection field classifying the second digital airspace area of operation as the pilot area, and creating the pilot area based at least in part on the third user input.

Alternatively, pilot areas may be created automatically for oversight areas. For example, a default pilot area may be generated automatically for an oversight area that includes a nest, with the default pilot area being located within the oversight area based on the location of the nest. In some embodiments, the pilot area comprises a four-dimensional space defined by a geographical area, an altitude dimension, and a time dimension.

Referring again to FIG. 7, in process block 740 the system creates a new flight mission or alters an existing flight mission within the pilot area based on the specified ruleset(s). For example, a route planning engine may take the ruleset(s) into consideration when planning routes for a new flight mission, to ensure that a planned route complies with the rules of the ruleset(s). As another example, a previously planned route for an existing flight mission may be adjusted or deleted in response to changes in the ruleset(s) specified for a particular oversight area, which may in turn lead to corresponding changes in ruleset(s) specified for pilot areas within the oversight area. As another example, a previously planned route for an existing flight mission may be adjusted or deleted in response to changes in conditions covered by dynamic rules (e.g., changes in prevailing weather conditions that may allow or forbid a given type of UAV to operate, temporary flight restrictions, etc.).

The features or parameters of the oversight area or pilot area may be based on further information or user inputs. For example, in some embodiments, a geographical area selection field in the UI is configured to specify an x-y axis boundary of the oversight area or pilot area that defines the geographical area of the oversight area or pilot area. In such embodiments, the x-y boundary may be specified by a shape drawn on a 2D map in the geographical area selection field, and the oversight area or pilot area may be further based on the shape drawn on the 2D map. In some embodiments, an altitude field is presented in the UI, and the oversight area or pilot area may be further based on user input from interaction with the altitude field, as user inputs specifying a floor or ceiling altitude for the oversight area or pilot area.

The processes explained above are described in terms of computer software and hardware. The techniques described may constitute computer-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method for managing an airspace used by a fleet of unmanned aerial vehicles (UAVs), the method comprising, by a fleet management system comprising one or more computing devices:
initiating creation of a first digital airspace area of operation;
presenting in a user interface (UI) an area classifier selection field configured to select from a set of available area classifiers;
receiving first user input from interaction with the area classifier selection field classifying the first digital airspace area of operation as an oversight area;
presenting in the UI a ruleset selection field configured to specify one or more rulesets of the oversight area;
receiving second user input from interaction with the ruleset selection field specifying the one or more rulesets of the oversight area;
creating the oversight area based at least in part on the first and second inputs; and
creating a pilot area associated with the oversight area that inherits the one or more specified rulesets of the oversight area.

2. The method of claim 1, wherein the one or more specified rulesets comprise rules related to flight approvals, and wherein the method further comprises creating a new flight mission or altering an existing flight mission based on the one or more specified rulesets.

3. The method of claim 1, wherein the oversight area comprises a four-dimensional space defined by a geographical area, an altitude dimension, and a time dimension.

4. The method of claim 1 further comprising:
presenting in the UI a geographical area selection field configured to specify an x-y axis boundary of the oversight area, wherein the x-y boundary of the oversight area is specified by a shape drawn on a two-dimensional (2D) map in the geographical area selection field,
wherein creating the oversight area is further based on the shape drawn on the 2D map.

5. The method of claim 1 further comprising presenting an altitude field in the UI, wherein creating the oversight area is further based on user input from interaction with the altitude field.

6. The method of claim 1, wherein creating the pilot area comprises:
initiating creation of a second digital airspace area of operation;
receiving third user input from interaction with the area classifier selection field classifying the second digital airspace area of operation as the pilot area; and
creating the pilot area based at least in part on the third user input.

7. The method of claim 6 further comprising:
presenting in the UI a geographical area selection field configured to specify an x-y axis boundary of the pilot area that overlaps or is contained within the oversight area, wherein the x-y boundary of the pilot area is specified by a shape drawn on a two-dimensional (2D) map presented in the geographical area selection field; and
wherein the pilot area is further based on the shape drawn on the 2D map.

8. The method of claim 6, wherein the pilot area specifies a four-dimensional space defined by a geographical area, an altitude dimension, and a time dimension, wherein flight operations overseen by a pilot responsible for controlling one or more UAVs are allowed within the pilot area, and wherein the pilot area overlaps or is contained within the oversight area.

9. The method of claim 1, further comprising presenting a sortable area list field in the UI including a list of existing digital airspace areas of operation.

10. The method of claim 1, further comprising presenting UI elements that permit editing an existing digital airspace area of operation in response to user selection of the existing digital airspace area of operation.

11. The method of claim 10, wherein the UI elements that permit editing vary depending on whether the existing digital airspace area of operation is an oversight area or a pilot area.

12. The method of claim 1, wherein the one or more specified rulesets comprise a first ruleset for flights entirely within a controlled airspace and a second ruleset for flights at least partially outside the controlled airspace.

13. At least one non-transitory computer-readable medium having logic stored thereon that, in response to execution by one or more processors of a fleet management system, cause the fleet management system to perform operations for managing an airspace used by a fleet of unmanned aerial vehicles (UAVs), the operations comprising:
initiating creation of a first digital airspace area of operation;
presenting in a user interface (UI) an area classifier selection field configured to select from a set of available area classifiers;
receiving first user input from interaction with the area classifier selection field classifying the first digital airspace area of operation as an oversight area;
presenting in the UI a ruleset selection field configured to specify one or more rulesets of the oversight area;
receiving second user input from interaction with the ruleset selection field specifying the one or more rulesets of the oversight area;
creating the oversight area based at least in part on the first and second inputs; and
creating a pilot area associated with the oversight area that inherits the one or more specified rulesets of the oversight area.

14. The at least one non-transitory computer-readable medium of claim 13, wherein the one or more specified rulesets comprise rules related to flight approvals, the operations further comprising creating a new flight mission or altering an existing flight mission based on the one or more specified rulesets.

15. The at least one non-transitory computer-readable medium of claim 13, wherein the pilot area and the oversight area each specify a four-dimensional (4D) space defined by geographical area, altitude, and time, wherein flight operations overseen by a pilot responsible for controlling one or more UAVs are allowed within the 4D space of the pilot area, and wherein the pilot area overlaps or is contained within the 4D space of the oversight area.

16. The at least one non-transitory computer-readable medium of claim 13, the operations further comprising:
presenting in the UI a geographical area selection field configured to specify an x-y axis boundary of the oversight area, wherein the x-y boundary of the oversight area is specified by a shape drawn on a two-dimensional (2D) map in the geographical area selection field,
wherein creating the oversight area is further based on the shape drawn on the 2D map.

17. The at least one non-transitory computer-readable medium of claim 13, the operations further comprising presenting an altitude field in the UI, wherein creating the oversight area is further based on user input from interaction with the altitude field.

18. The at least one non-transitory computer-readable medium of claim 13, wherein creating the pilot area comprises:
initiating creation of a second digital airspace area of operation;
receiving third user input from interaction with the area classifier selection field classifying the second digital airspace area of operation as the pilot area;
presenting in the UI a geographical area selection field configured to specify an x-y axis boundary of the pilot area that overlaps or is contained within the oversight area, wherein the x-y boundary of the pilot area is specified by a shape drawn on a two-dimensional (2D) map presented in the geographical area selection field; and
wherein the pilot area is based on the third user input and the shape drawn on the 2D map.

19. The at least one non-transitory computer-readable medium of claim 13, the operations further comprising presenting UI elements that permit editing an existing digital airspace area of operation in response to user selection of the existing digital airspace area of operation, wherein the UI elements that permit editing vary depending on whether the existing digital airspace area of operation is an oversight area or a pilot area.

20. The at least one non-transitory computer-readable medium of claim 13, wherein the one or more specified rulesets comprise a first ruleset for flights entirely within a controlled airspace and a second ruleset for flights at least partially outside the controlled airspace.
